(19) United States
(12) Patent Application Publication
(10) Pub. No.: US 2003/0177134 A1
(43) Pub. Date: Sep. 18, 2003

(54) DVD player selecting MP3 files in units of directories and method thereof

(75) Inventor: Eun-mi Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/367,972

(22) Filed: Feb. 19, 2003

(30) Foreign Application Priority Data
Feb. 19, 2002 (KR) 2002-8755

(51) Int. Cl. G06F 7/00

(52) U.S. Cl. 707/100

(57) ABSTRACT

A digital versatile disc (DVD) MP3 data reproducing apparatus which reproduces MP3 files recorded in a directory structure on a DVD storage medium according to MP3 file directory units. The apparatus has a file management controller which enables a user to select and release the selection of the MP3 file directories read from the storage medium and a reproduction unit which reproduces or repetitively reproduces only MP3 files belonging to the MP3 file directory selected by a reproduction or repetitive reproduction command.

### CROSS-REFERENCE TO RELATED APPLICATIONS

This application claims priority from Korean Patent Application No. 2002-8755 filed Feb. 19, 2002, the disclosure of which is incorporated herein by reference in its entirety.

### BACKGROUND OF THE INVENTION

1. Field of the Invention

The present invention relates to a Digital Versatile Disc (DVD) MP3 reproducing apparatus (DVD player), and more particularly, to a DVD reproducing apparatus which selects MP3 files in units of directories when MP3 data files are reproduced, such that functions for conveniently selecting files and repetitively reproducing thus selected files can be provided to users, and a method thereof.

2. Description of the Related Art

MP3 is a compression/encoding standard for audio data. The use of the MP3 has been rapidly increasing recently, because it needs a relatively low storage capacity thanks to a high compression ratio and guarantees higher sound quality when data is reproduced. Together with frequent use of MP3 data, the use of reproducing apparatuses for MP3 data has also been increasing.

In general, the prior art DVD MP3 players have only very simple functions for reproduction or repetitive reproduction of data, such that user convenience is not considered. This seems to be attributed to the fact that most functions of DVD MP3 players are borrowed from non-MP3 compact/optical disc (CP) players, which do not use the MP3 standard for data storage.

Regarding the repetitive reproduction function, for example, an ordinary DVD MP3 reproducing apparatus can repetitively reproduce MP3 files only in units of songs (files) or can repetitively reproduce only the entire (all of the) MP3 files. However, since the number of MP3 files recorded in a DVD storage medium can be more than 400, the function of repetitively reproducing all of the MP3 files may be useless or meaningless. A conventional MP3 DVD reproducing apparatus which reproduces MP3 files in a more advanced method provides a so-called ‘program’ function by which if a user selects files desired to be reproduced from among MP3 files recorded on a DVD storage medium, only the selected files are repetitively reproduced. However, even in this case, finding desired files from among a lot of MP3 files and adding the found files to a program list will cause inconvenience to the user. Also, when desired MP3 files are selected, index selection of each MP3 file needs memory space corresponding to the selection.

### SUMMARY OF THE INVENTION

The present invention provides a DVD MP3 file reproducing apparatus enabling selection of MP3 files in units of directories, which has functions for enabling a user to select MP3 files in units of directories, to reproduce files in a selected directory and to repetitively reproduce the files, and a method thereof. Accordingly, the present invention overcomes inconveniences in reproducing MP3 files in a DVD player (reproducer).

Additional aspects and advantages of the invention will be set forth in part in the description which follows and, in part, will be obvious from the description, or may be learned by practice of the invention.

The present invention can be achieved by a DVD reproducing apparatus which reproduces MP3 files recorded in a directory structure on a storage medium (i.e., a DVD), the apparatus comprising a file management control unit which enables a user to select and release the selection of the MP3 file directories read from the storage medium in units of directories.

According to an aspect of the present invention, the file management control unit displays the MP3 file directory structure read from the storage medium so as to enable a user to select and release the selection of each directory.

According to an aspect of the present invention, if a predetermined directory is selected by the user and a reproduction command is input, only files belonging to the selected directory are reproduced.

According to an aspect of the present invention, if a predetermined directory is selected by the user and a repetitive reproduction command is input, only files belonging to the selected directory are repetitively reproduced.

The present invention may also be achieved by a DVD MP3 data storage medium reproducing method for a DVD reproducing apparatus reproducing MP3 data recorded in a directory structure on a storage medium (i.e., a DVD), the method comprising reading data on the storage medium and displaying the directories and files belonging to respective directories, enabling a user to select or release the selection of each displayed directory; and if one or more directories are selected by the user, reproducing or repetitively reproducing only files belonging to the selected directories according to a reproduction command or a repetitive reproduction command.

According to an aspect of the present invention, selection and release of the selection of the displayed directories are performed through a display window having a predetermined format.

According to an aspect of the present invention, selection and release of the selection of the directory are performed through changes of font color of each displayed directory.

The present invention may also be achieved by a DVD reproducing apparatus which reproduces MP3 files recorded in a directory structure on a storage medium (i.e., a DVD), the apparatus comprising a file management control unit which enables a user to select and release the selection of the MP3 file directories read from the storage medium in units of directories; and a reproduction unit which reproduces or repetitively reproduces only files belonging to the directory selected in response to a reproduction or repetitive reproduction command.

According to an aspect of the present invention, when the MP3 file directory structure read from the storage medium is displayed, the file management control unit displays a selection window in a predetermined shape for each displayed directory so as to enable a user to select and release the selection of each displayed directory.

According to an aspect of the present invention, the file management control unit displays the MP3 file directory structure read from the storage medium, and changes font color of each displayed directory when a user selects and releases the selection of each directory.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a functional block diagram of a DVD MP3 file reproducing apparatus reproducing MP3 files in units of directories, according to an embodiment of the present invention; and

FIG. 2 is a flowchart of reproducing MP3 data recorded in a directory structure on a DVD, according to an embodiment of the present invention.

FIG. 3 is an example display of MP3 file directories, according to an embodiment of the present invention.

FIG. 4 is an example display of selectable MP3 file directories, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

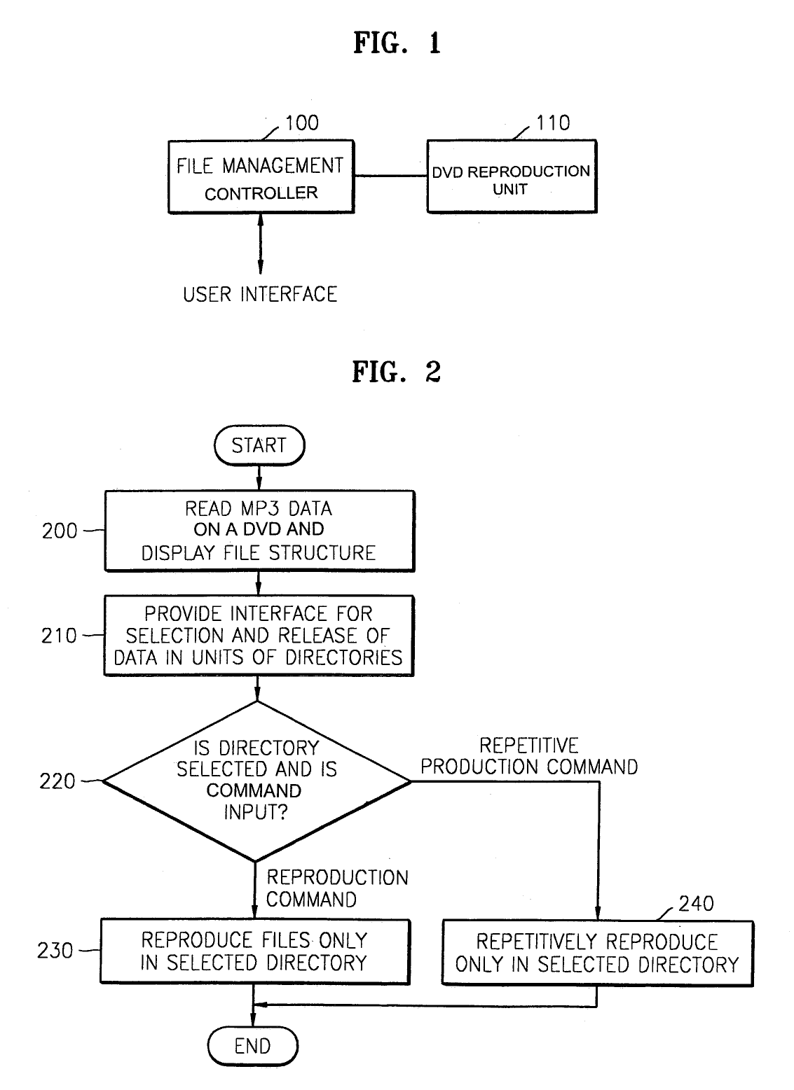

FIG. 1 is a functional block diagram of a DVD MP3 file reproducing apparatus, according to an embodiment of the present invention. The DVD MP3 file reproducing apparatus of FIG. 1 comprises a file management controller 100 and a DVD reproduction unit 110, which can reproduce multimedia, including MP3 data, according to the DVD technology. In FIG. 1, only elements related to directory-basis reproduction functions of a DVD MP3 data storage medium of the present invention are shown, and the remaining elements related to signal processing or user interface are not shown and the explanation is omitted because those elements can be fully understood by those skilled in the art.

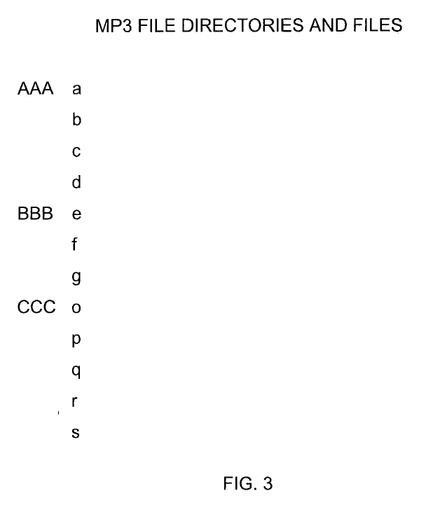

In general, a DVD storage medium in which MP3 data are stored also contains MP3 data structure information. A DVD MP3 reproducing apparatus reads the MP3 data structure information and displays the structure (e.g., MP3 file directory name, MP3 file name, attributes, etc.) in a predetermined display part (not shown) of the DVD MP3 reproducing apparatus. For example, assuming that files a, b, c, and d are in MP3 file directory (directory) AAA, MP3 files e, f, and g are in directory BBB, and files o, p, q, r, and s are in directory CCC, the DVD MP3 reproducing apparatus can display MP3 file information in the display part as shown in FIG. 3 (display example 1).

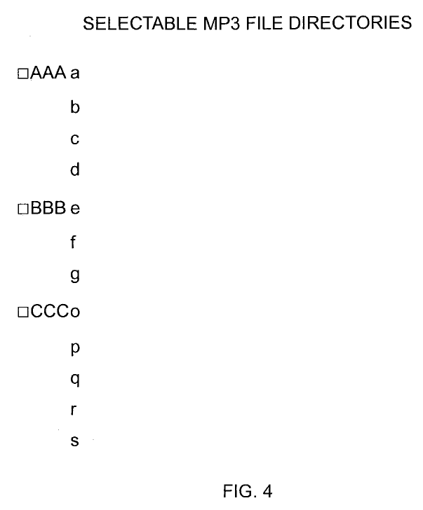

While reading and displaying the MP3 file structure of the directory structure described above from the storage medium (i.e., the DVD), the file management controller 100 of FIG. 1 provides an interface function with which the user can select a directory from among the displayed directories MA, BBB, and CCC, and release the directory selection. This interface function can be displayed, for example, as shown in FIG. 4 (display example 2).

In FIG. 4, by selecting the displayed window □ shown in front of each displayed MP3 file directory, the user can select a directory and release the selected directory. That is, the MP3 file directory selection and release functions can be determined, such that when a check mark, for example, v or ✓, appears in the display window □, the directory is deemed selected, or else the directory is deemed not selected.

Using the display check box selection technique described above, the file management controller 100 can provide the user with functions for selecting a directory and releasing the directory selection. In addition, according to another aspect of the present invention, the file management controller 100 may enable the user to change font color of any displayed MP3 file directory, such as the FIG. 4 directories AAA, BBB, and CCC, when the user selects or releases the selection of a directory. The concepts of checking a box and changing a font color of displayed MP3 file directories are just examples and a variety of methods may be provided in relation to selection of an MP3 file directory.

When the user selects a directory (selection of a plurality of directories is also available) with the functions provided by the file management controller 100, the DVD reproduction unit 110 reproduces only files in the directory selected by a reproduction command. For example, if the user selects directory AAA and inputs a reproduction command, only files a, b, c, and d that belong to the selected directory are reproduced. Also, when a repetitive reproduction command is input, the reproduction unit 110 repetitively reproduces only files in directory AAA selected by the user. The repetitive reproduction sequence may be shown as a, b, c, d, a, b, c, d, a, . . . . The DVD reproduction unit 110 is configured (e.g., programmed, etc.) to receive and process control information from the file management controller 100 to process (e.g., reproduce, repetitively reproduce, etc.) MP3 data according to MP3 file directory units.

The above-described apparatus selecting files in units of MP3 file directories enables selection of a plurality of files belonging to a directory with a minimum of a 1-bit memory space that may be needed in selecting one directory, minimizing file selection memory needs.

FIG. 2 is a flowchart of reproducing MP3 data recorded in a directory structure on a DVD, according to an embodiment of the present invention. First, at operation 200, a DVD reproducing apparatus reads information on the structure of MP3 data from the storage medium, and displays the read information on the MP3 data structure in the storage medium to the user. For example, this may be the same as the display example 1 shown in FIG. 3.

At this time, if the MP3 data are recorded in a directory structure, at operation 210, the DVD reproducing apparatus (i.e., a DVD MP3 reproducing apparatus) provides the user with a user interface function for selecting files and releasing the file selections in units of directories. This may be the same as the display example 2 shown in FIG. 4, in which a predetermined display window is added to each displayed MP3 file directory so that the user can check the window to select the directory or delete/remove the check to deselect the directory. Also, the user interface function may allow the user to click on a directory to change the font color of the directory, such that it is determined whether a directory is selected.

If the user selects one or more directories using the interface function provided at operation 210 and, at operation 220, inputs a reproduction command for the selected directories, at operation 230, the DVD MP3 reproducing apparatus reproduces only files in the selected directory/directories. If, at operation 220, the user inputs a repetitive reproduction command, at operation 240, the DVD MP3 reproduction apparatus repetitively reproduces only files in the selected directory/directories. In particular, at operation 220, the MP3 files in a selected MP3 directory are processed according to an input processing command (i.e., MP3 file processing in units of directories).

As described above, when the DVD reproducing apparatus of the present invention reproduces MP3 files, functions can be provided for selecting MP3 files in units of MP3 file directories, and processing, such as reproducing and repetitively reproducing, the MP3 files in the selected MP3 file directories. Accordingly, the functions in the prior art, which are limited to repetitive reproduction of only one MP3 file or the entire MP3 files in a DVD storage, can be expanded. Also, the present invention overcomes the inconvenience as well as increased memory needs of the alternative functions in the prior art in which a user selects MP3 files one by one to control reproduction or repetitive reproduction of the selected MP3 files.

Considering that the structure of files in a storage medium is typically based on grouping related files in one directory (i.e., creating MP3 file directories as desired), selecting MP3 files in units of MP3 file directories is expected to be widely used by users. More particularly, according to the present invention, to reproduce MP3 data from a DVD, an MP3 data controller enables MP3 file selection and reproduction (play) by a user in units of MP3 file directories, such that the convenience of MP3 file selection improves by using a minimum memory space, and functions for reproduction and repetitive reproduction of the selected MP3 files are conveniently provided and used. Although the above-described embodiments provide DVD MP3 file reproduction based upon selected MP3 directories (i.e., MP3 directory reproduction), the present invention is not limited to such a configuration, such that any MP3 operation/process, such as recording, downloading, etc., can be performed based upon directories. Accordingly, the present invention provides DVD MP3 directory processing. The processes of the present invention as embodied in the file management controller 100 and the DVD reproduction unit 110 can be implemented in computing hardware and/or software.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A digital versatile disc (DVD) reproducing apparatus which reproduces MP3 files recorded in a directory structure on a DVD storage medium, comprising:
a file management controller enabling a user to select and release the selection of the MP3 file directories read from the storage medium.

2. The DVD reproducing apparatus of claim 1, wherein the file management controller displays the MP3 file directory structure read from the storage medium to enable the user to select and release the selection of each MP3 file directory.

3. The DVD reproducing apparatus of claim 1, wherein if a predetermined MP3 file directory is selected by the user and a reproduction command is input, only files belonging to the selected MP3 file directory are reproduced.

4. The DVD reproducing apparatus of claim 1, wherein if a predetermined MP3 file directory is selected by the user and a repetitive reproduction command is input, only files belonging to the selected MP3 file directory are repetitively reproduced.

5. A method of reproducing MP3 data recorded in a directory structure on a digital versatile disc (DVD) storage medium, comprising:
reading data from the storage medium and displaying MP3 file directories and MP3 files belonging to the MP3 file directories, respectively;
enabling a user to select or release the selection of each MP3 file directory; and
reproducing or repetitively reproducing MP3 files belonging to the selected MP3 file directories according to a reproduction command or a repetitive reproduction command.

6. The method of claim 5, wherein the selection and the release of the selection of the MP3 file directories are performed through a display window having a predetermined format.

7. The method of claim 5, wherein the selection and the release of the selection of the MP3 file directories are performed through changes of font color of the displayed MP3 file directories.

8. A digital versatile disc (DVD) reproducing apparatus which reproduces MP3 files recorded in a directory structure on a DVD storage medium, comprising:
a file management controller enabling a user to select and release the selection of the MP3 file directories read from the storage medium in units of directories; and
a DVD reproduction unit reproducing or repetitively reproducing the MP3 files belonging to the MP3 file directory selected by a reproduction or a repetitive reproduction command.

9. The DVD reproducing apparatus of claim 8, wherein when the MP3 file directory structure read from the storage medium is displayed, the file management controller displays a selection window in a predetermined shape for each displayed MP3 file directory to enable the user to select and release the selection of each MP3 file directory.

10. The DVD reproducing apparatus of claim 8, wherein the file management controller displays the MP3 file directory structure read from the storage medium, and changes font color of each displayed MP3 directory when a user selects and releases the selection of each MP3 file directory.

11. The DVD reproducing apparatus of claim 8, further comprising a 1-bit memory for each selected MP3 file directory.

12. A digital versatile disc (DVD) MP3 reproducing apparatus, comprising:
a controller enabling MP3 file selection and processing in units of MP3 file directories, thereby using a minimum file-selection memory space.
